(19) United States
(12) Patent Application Publication
(10) Pub. No.: US 2023/0389713 A1
(43) Pub. Date: Dec. 7, 2023

(54) MATTRESS ASSEMBLY INCLUDING COIL INNERSPRING UNITS, COIL INNERSPRING UNITS, AND PROCESSES FOR MAKING THE SAME

(71) Applicant: DREAMWELL, LTD., Doraville, GA (US)

(72) Inventors: Stephen M. Groppel, Appleton, WI (US); Ben Storch, Athens, GA (US); Jeffrey Mastropaolo, Suwanee, GA (US); Dishant Purani, Brampton (CA)

(21) Appl. No.: 18/314,297

(22) Filed: May 9, 2023

Related U.S. Application Data
(60) Provisional application No. 63/340,076, filed on May 10, 2022.

(51) Int. Cl. A47C 27/06; B68G 3/00; B68G 7/00

(52) U.S. Cl. CPC A47C 27/062; A47C 27/064; B68G 3/00; B68G 7/00

(57) ABSTRACT

Mattress assemblies including coil innerspring units, coil innerspring units by themselves, and processes for making the coil innerspring units, wherein the coils within the coil innerspring unit are manufactured with the same geometry, same composition, and from the same gauge wire using different heat treatments to provide the coil innerspring unit with different spring rates.

### CROSS-REFERENCE TO RELATED APPLICATIONS

This application claims the benefit of U.S. Provisional Application No. 63/340,076, filed May 10, 2022, the disclosure of which is incorporated herein by reference in its entirety.

### BACKGROUND

The present disclosure generally relates to mattress assemblies, and more particular, to mattress assemblies including coil innerspring units, coil innerspring units by themselves, and processes for making the coil innerspring units, wherein the coils within the coil innerspring unit are manufactured with the same geometry, same composition, and from the same gauge wire using different heat treatments to provide the coil innerspring unit with different spring rates.

The production of coil springs for use in mattress assemblies has been in existence for a long time. Historically, coil innerspring units have been created for different consumer firmness targets, which are generally based on coil geometry that includes variables such as wire gauge, diameter, number of active turns, the choice of materials used, stranding, and the like. In more recent years, the coil innerspring units are fabricated using strings of pocketed coil springs, wherein each coil spring is captured or encased within a pocket material. An assembly of this type is known as Marshall construction and is disclosed, for example, in U.S. Pat. No. 4,234,983, issued to Stumpf and assigned to the common assignee herein, the disclosure of which is expressly incorporated herein by reference. Pocketed strings of coils can be readily manufactured by apparatus disclosed, for example, in U.S. Pat. No. 4,401,501 also issued to Stumpf and assigned to the common assignee herein, the disclosure of which is likewise incorporated herein by reference. The latter patent teaches producing a string of pocketed coil springs by inserting the coils into spring pockets formed by ultrasonic welding of a tube of appropriate heat sensitive fabric. Alternatively, the strings can be joined together using adhesives or a combination of welding and adhesives. Once the strings of coils are formed, they may be arranged in any desired fashion such as a chevron or other pattern to provide a coil innerspring unit assembly in Which the individual springs all have longitudinal axes oriented parallel one to another and the springs are closely packed together in an array having a generally rectangular shape in plan with the ends of the springs lying in a common plane. A suitable quilted or non-quilted foam pad of preselected thickness may then be used to cover the coil innerspring unit and provide a generally planar surface on which a person can sleep. Typically, the coil innerspring unit is covered on both sides and has fabric edging connecting the opposed surface covers, thereby defining a unitary mattress assembly.

To increase comfort to the consumer, it is fairly common for the coil springs in these coil innerspring units to utilize more than one type of coil geometry to provide different spring rates in different portions of the mattress assembly. For example, to prevent edge roll off, perimeter coils can be configured to provide increased firmness relative to the inner coils within the coil innerspring unit. To provide spinal alignment, the inner coils within coil innerspring unit can be configured with two or more zones of coils having different spring rates. In these types of applications, the coil spring geometries can be different relative to coil springs in one location compared to another location, which can be achieved by using different gauge wire, different coil geometries, or the like. The use of different coil geometries and different gauge wires creates a burden for the mattress manufacturer as it needs to be cognizant of which strings of coils are to be placed into the innerspring unit and at which location in order to create the desired mattress. Additionally, there are added costs due to having coils of different geometries or the need to switch over to a different gauge wire in a mattress construction and due to the processing method of the coil unit, which is generally less efficient than if manufacturing an innerspring unit of a mattress assembly in its entirety with a single gauge wire and of the same coil geometry.

### BRIEF SUMMARY

Disclosed herein mattress assemblies including coil innerspring units, coil innerspring units by themselves, and processes for making the coil innerspring units, wherein the coils within the coil innerspring unit are manufactured with the same geometry, same composition, and from the same gauge wire using different heat treatments to provide the coil innerspring unit with different spring rates.

In one or more embodiments, a process for producing a coil innerspring unit includes forming a plurality of first coils from a wire, wherein a selected one of the plurality of first coils or the wire are exposed to a first heat treatment process to provide the plurality of coils with a first spring rate; forming a plurality of second coils from the wire free of a heat treatment process to provide a second spring rate; and arranging the plurality of the first and second coils in a side-by-side relationship to form the coil innerspring unit. The first spring rate is different from the second spring rate, and the first coils and the second coils have an identical geometry.

In one or more embodiments, the process for producing a coil innerspring unit includes heat treating a wire prior to or subsequent to forming heat-treated coil springs from the wire and forming the heat-treated coil springs if the wire is heat treated prior to forming the coil springs; arranging the heat-treated coil springs in at least one zone within the coil innerspring unit, wherein the heat-treated coil springs have an identical geometry to each other; and arranging additional coil springs having a second spring rate in at least one additional zone, wherein the first spring rate is different from the second spring rate, and wherein the additional coil springs have the identical geometry to the heated treated springs and are formed from a wire having an identical gauge and composition.

In one or more embodiments, a coil innerspring unit for a cushioning article having at least two sets of coils includes a first set of coils springs, wherein each of the coil springs has a first spring rate; and a second set of coil springs wherein each of the coil springs has a second spring rate, wherein the coil springs in the first and second sets comprise an identical geometry, gauge wire, and composition.

In one or more embodiments, mattress assembly includes a coil innerspring unit comprising a first set of coils springs, wherein each of the coil springs has a first spring rate; and a second set of coil springs wherein each of the coil springs has a second spring rate, wherein the coil springs in the first and second sets comprise an identical geometry, gauge wire, and composition.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

Prior Art FIG. 1 (“FIG.”) is a perspective view, partially broken away, of a prior art exemplary mattress assembly including a coil innerspring unit;

FIG. 2 is a fractional side perspective view of a string of coils of a type used in the exemplary mattress assembly of FIG. 1;

FIG. 3 is top plan view of a coil innerspring unit including multiple zones including sets of coils formed using different heat treatment processes, wherein the coil springs are formed with the same geometry, composition, and gauge in accordance with the present disclosure; and

FIG. 4 graphically illustrates deflection as a function of applied force for coil springs formed with the same geometry, composition, and gauge and exposed to different heat treatment processes in accordance with the present disclosure.

### DETAILED DESCRIPTION

Disclosed herein are mattress assemblies including a coil innerspring unit, coil innerspring units by themselves for use in cushioning articles, and processes for fabricating the coil springs utilized in the coil innerspring unit. In one or more embodiments, the coil springs in the coil innerspring units are encased in a fabric pocket to form pocketed coil springs having the same geometry, wire composition, and manufactured with the same gauge steel wire. Applicants have unexpectedly found that applying different heat treatment processes to the wire prior to formation of the coil or to the coil subsequent to formation can alter the resulting spring rate.

The heat treatment processes are not intended to be limited and may include at least one of annealing, hardening, precipitation strengthening, tempering, quenching and austenizing. The process of annealing typically assists in changing properties such as strength and hardness. Annealing may be used to induce softness, relieve internal stresses within the alloyed rods and refine its structure. Hardening, tempering and quenching typically involve heating the alloyed rod to a high temperature into an austenitic crystal phase and then quickly cooled. Tempering and quenching may be used to improve ductility and impart some toughness. In certain embodiments, the nature and number of heat treatment cycles may be selected and performed based on, among other things, at least one of the austenite, pearlite and ferrite ratios of the steel wire.

Although reference will be made to pocketed coils, it should be apparent that the present disclosure of altering spring rate based on heat treatment is equally applicable to individual coil springs that are not encased. The mattress assemblies including the coil innerspring unit can include multiple zones having different firmness properties defined by the heat treatment process while utilizing the same coil geometry, composition, and gauge. Advantageously, the process of making the coil innerspring unit with coil springs having the same coil geometry, wire composition, and wire gauge significantly increases processing efficiency since the coiling unit assemblers can be readily configured to apply or not apply a heat treatment process to the coil springs prior to or subsequent to forming the coil unit geometry.

In one or more embodiments, the heat treatment process generally includes resistively heating the coil spring or the wire prior to forming the coil spring to a specific temperature by application of a current for a relatively short period of time followed by cooling to about room temperature. The resistive heat treatment process can be continuous or discontinuous generally depending on the processing equipment. Some coiling unit assemblers provide the capability to resistively heat treat portions of the wire being fed into the assembler, which can be altered on the fly.

In one or more embodiments, the heat treatment process includes the step of heating a wire from a wire spool prior to forming the coil spring or heating a cold formed coil spring to a tempering temperature. In one or more embodiments, the wire prior to forming the cod spring or the cold formed coil spring can be tempered. By way of example, the wire prior to forming the coil spring or the cold formed coil spring can be heated by applying a resistive current to heat the wire or coil for a defined period of time generally depending on the amount of the current, i.e., the higher the current, the less time needed to achieve the desired temperature. The period of time for applying the current to achieve the desired temperature to produce a coil can be on the order or milliseconds to seconds.

Material selection of the steel wire is not intended to be limited and can be based on a number of factors including temperature range, tensile strength, elastic modulus, fatigue life, corrosion resistance, cost, etc. One or more alloying elements may be combined as desired to modify the aforementioned factors. In other embodiments, the wire or the coil can be surface treated with a material that can withstand the heat treatment process or subsequently coated, e.g., galvanized or coated with a plastic or epoxy.

In one or more embodiments, the coil springs are multistranded coils including at least two strands of wires twisted to form the multistrand coil. Each strand may be formed from a similar wire composition and gauge. However, the number of strands employed can vary according to the application and the type of material used to form the strands. In some constructions, the multistranded coil spring is formed from braiding or twisting three or more strands. In one construction, the multi-strand cord includes from three to about fifty twisted or braided strands. The strands may be twisted, woven, clipped or bonded together, and any suitable method for forming the multistrand coil spring may be employed. Moreover, the wire may have an ovular, circular, hexagonal, square, flattened version of any of the preceding or any other suitable cross-sectional geometry, and may be formed into any number of coils. Also, the coil springs themselves may be formed as active or inactive coils, and may all have substantially equal coil diameters. Alternatively, the coil diameter may vary from coil to coil, and may be arranged, for example to have sequentially increasing coil diameters, sequentially decreasing coil diameters, or some combination of both, to for many suitable coil diameter pattern, for example, for forming a coil spring having a variable spring rate. The individual strands may be connected to each other at least at the ends of the coil.

Referring now to PRIOR ART FIG. 1, there is depicted an exemplary mattress assembly generally designated by reference numeral 10 including a frame assembly 12, a box spring 14 and a mattress 16. The mattress 16 is constructed in a manner well-known in the art and includes a layer of a plurality of pocketed coil springs 30, as will be described in detail hereinafter, arranged in an array having a generally rectangular shape in plan. As seen in MG. 1, the coil springs 30 are closely packed together with their longitudinal axes A-A all parallel one to another and with their longitudinal ends 31, 32 all lying in a common plane thereby defining a coil innerspring unit 20. A suitable containment strap 22 and corner members 24 may be used to reinforce the shape of the coil innerspring unit 20. In a well-known manner, the coil innerspring unit 20 is covered with a panel 26 which may be a quilted or non-quilted assembly of foam and fabric, thereby defining a sleeping surface. Although not shown in FIG. 1, the mattress may have an underside which can be identical in construction to the top side and which includes a cover likewise coextensive with the coil innerspring unit 20. The top side cover panel 26 is joined to the underside cover panel by continuous edging 28 consisting of fabric.

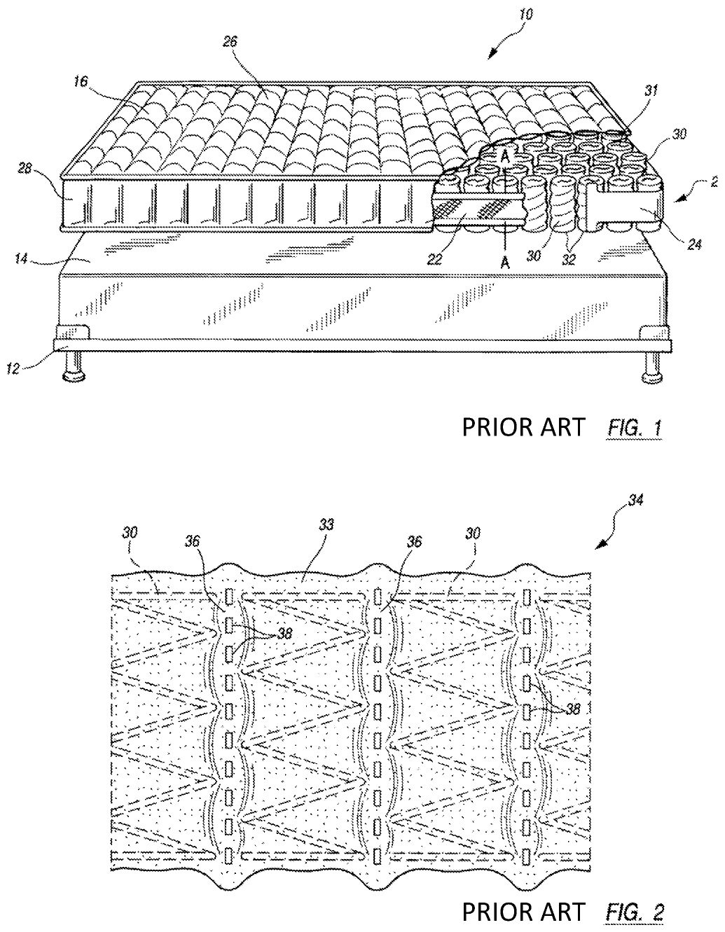

Turning now to PRIOR ART FIG. 2, the construction of the coil innerspring unit 20 can be seen to include a plurality of coil springs 30 each encapsulated in an individual pocket of fabric 33, pocket coils. The pockets are typically formed from heat sensitive fabric 33 and are assembled as an elongated continuous string 34 by ultrasonically welding the fabric 33 at webs 36 formed between adjacent springs 30. Welds 38 can made at spaced intervals along the webs 36 to assure adequate strength of the assembled string 34. Multiple strings can be used to form the coil innerspring unit, which can be welded or adhesively coupled to provide the desired shape of the coil innerspring unit.

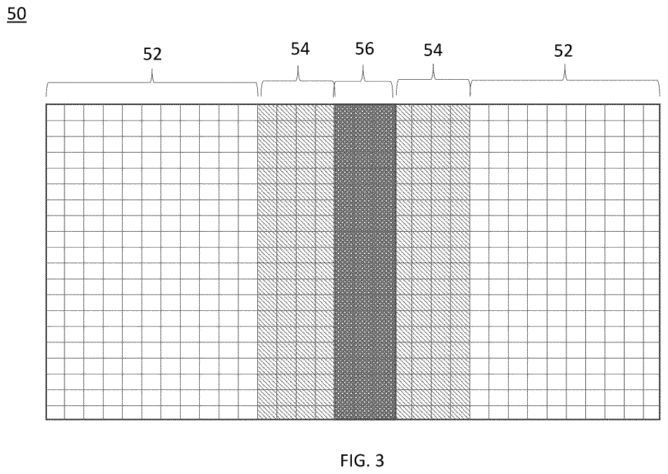

In FIG. 3, there is depicted a top-down view of a coil innerspring unit 50 including multiple strings of pocketed coil springs. The coil innerspring unit 50 is manufactured using the same coil geometry, the same steel wire composition, and the same gauge wire, wherein the coil springs in three zones 52, 54, and 56 are each subjected to different heat treatments. In zones 52, the coil springs are not subjected to any heat treatment step to provide the coil springs with a first spring rate; in zones 54, the coils are subjected to 50% heat treatment to provide the coil springs with a second spring rate, and in zone 56, the coils are subjected to 100% heat treatment to provide the coil springs with a third spring rate, wherein the first, second and third spring rates are different from one another. Changing the heat treatment in each of the zones results in different firmness properties within the particular zones, which translates to a different feel experienced by the consumer across the different zones of the mattress surface. It should be noted that reference to percentage is arbitrary and not intended to be limiting. Any one of a number of variables can be varied in the heat treatment process including, for example, as in the case of resistive heating, the applied amperage and time duration. Moreover, the applied heat treatment process can be repeated as may be desired for different applications.

Although the coil innerspring unit as shown in FIG. 3 can have three zones of differing firmness, it should be appreciated that a coil innerspring unit can be constructed having any number of differing firmness zones to suit the particular preferences of the user or users. Thus, for example, differing firmness zones may be arranged lengthwise or widthwise of the innerspring unit to provide varying degrees of support for the head, torso or legs of the user as well as the perimeter of the innerspring unit. Moreover, the zones can be of any size relative to the overall size of the innerspring assembly. Thus if one user, for example, desires certain firmness characteristics over a greater portion of the mattress than another user desires, a coil innerspring unit can be constructed accordingly.

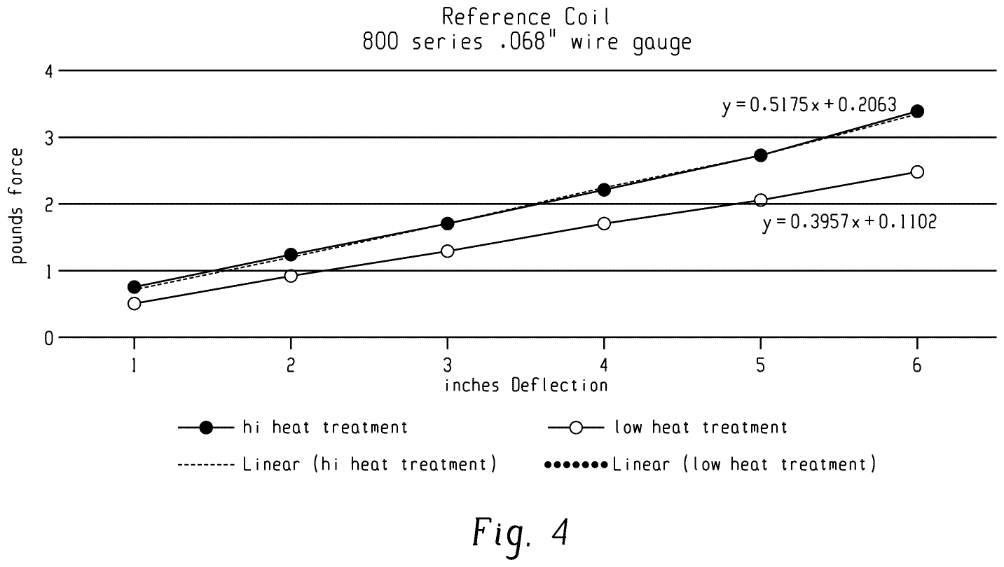

In FIG. 4, there is graphically illustrated deflection as a function of applied load for coil innerspring units formed of pocketed coils, wherein the individual coils were formed from 0.068 inch diameter gauge steel wire feedstock and had the same coil geometry and wire composition throughout the coil innerspring unit. Prior to forming the coil geometry, a length of the wire sufficient to fabricate the coil was exposed to either a high temperature resistive heat treatment process or a low temperature resistive heat treatment process.

Subsequent to heat treatment, the wire was coiled to provide 6.25 turns at a nominal diameter of about 2.5 inches and had an out-of-pocket height of 9.25 inches. The coils were compressed and inserted into fabric pockets that were subsequently sealed to provide a pocket height of about 8 inches. Strings of these coils were arranged and ultrasonically welded to one another to form each respective coil innerspring unit.

As shown, the spring rate varied as a function of the heat treatment, wherein the coil springs in the coil innerspring units exposed to the high heat treatment process resulted in a lower spring rate, i.e., increased firmness, relative to the coil springs in the innerspring units exposed to the low heat treatment process.

Advantageously, the use of the same coil geometry, gauge wire, and wire composition provides the manufacturer with the capability of continuous production of a coil innerspring unit without the need to change coil geometry or wire composition or wire gauge to provide the coil springs with different spring rates within the coil innerspring unit. Doing so, greatly increases the efficiency and costs for manufacturing the coil innerspring units. Moreover, weight of the coil innerspring unit can be better controlled since the same geometry, composition and gauge can be used to form the coils with different spring rates.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A process for producing a coil innerspring unit, the process comprising:
forming a plurality of first coils from a wire, wherein a selected one of the plurality of first coils or the wire are exposed to a first heat treatment process to provide the plurality of coils with a first spring rate;
forming a plurality of second coils from the wire free of a heat treatment process or to a second heat treatment process to provide a second spring rate; and
arranging the plurality of the first and second coils in a side-by-side relationship to form the coil innerspring unit, wherein the first spring rate is different from the second spring rate, and wherein the first coils and the second coils have an identical geometry and composition.

2. The process of claim 1, wherein the first coils are collectively arranged in one or more zones and the second coils are collectively arranged in one or more other zones, wherein the zones provide the coil innerspring unit with a different firmness property in each of the zones.

3. The process of claim 1 further comprising forming a plurality of third coils, wherein a selected one of the plurality of third coils or the wire are exposed to a third heat treatment process to provide the plurality of third coils with a third spring rate different from the first and second spring rates.

4. The process of claim 1, wherein forming the pluralities of the first and second coils comprises individually encasing each of the first and second coils in a fabric pocket and forming strings of pocketed coils such that each string consists of the first coils or the second coils.

5. The process of claim 1, wherein forming the pluralities of the first and second coils comprises individually encasing each of the first and second coils in a fabric pocket and forming strings of the pocketed coils such that each string comprises the first and second coils.

6. The process of claim 1, wherein the first heat treatment process comprises resistively heating the wire or the plurality of coils to a different temperature than the second heat treatment process.

7. The process of claim 1, wherein at the first coils and/or the second coils comprise multiple strands.

8. A process for producing a coil innerspring unit, the process comprising:
heat treating a wire prior to or subsequent to forming heat-treated coil springs from the wire and forming the heat-treated coil springs if the wire is heat treated prior to forming the coil springs;
arranging the heat-treated coil springs in at least one zone within the coil innerspring unit, wherein the heat-treated coil springs have an identical geometry to each other; and
arranging additional coil springs having a second spring rate in at least one additional zone, wherein the first spring rate is different from the second spring rate, and wherein the additional coil springs have the identical geometry to the heated treated springs and are formed from a wire having an identical gauge and composition.

9. The process of claim 8, wherein arranging the additional coil springs comprises heat treating the wire prior to or subsequent to forming the additional coil springs from the wire and forming the additional coil springs if the wire is heat treated prior to forming the additional coil springs, wherein the heat treating of the additional coil spring is different from the heat treating of the heat-treated coil springs.

10. The process of claim 8, wherein the additional coil springs are free from heat treating.

11. The process of claim 8, wherein forming the heat-treated coils having the first spring rate and the additional coils having the second spring rate comprises individually encasing each of the heat-treated coils and the additional coils in a fabric pocket and forming strings of pocketed coils such that each string consists of the heat-treated coils or the additional coils.

12. The process of claim 8, wherein forming the heat-treated coils having the first spring rate and the additional coils having the second spring rate comprises individually encasing each of the heat-treated coils and the additional coils in a fabric pocket and forming strings of pocketed coils such that each string comprises the heat-treated coils and the additional coils.

13. A coil innerspring unit for a cushioning article having at least two sets of coils, the coil innerspring unit comprising:
a first set of coils springs, wherein each of the coil springs has a first spring rate; and
a second set of coil springs wherein each of the coil springs has a second spring rate,
wherein the first and second sets of the coil springs comprise an identical geometry, gauge wire, and composition.

14. The coil innerspring unit of claim 13, wherein the first set of coil springs and the second set of coil springs are compressively encased in a fabric pocket and arranged in strings.

15. The coil innerspring unit of claim 14, wherein each string consists of the coil springs from the first set or the second set.

16. The coil innerspring unit of claim 14, wherein each string comprises coil springs from the first set and the second set.

17. A mattress assembly comprising:
a coil innerspring unit comprising a first set of coils springs, wherein each of the coil springs has a first spring rate; and a second set of coil springs, wherein each of the coil springs has a second spring rate, wherein the coil springs in the first and second sets comprise an identical geometry, gauge wire, and composition.

18. The coil innerspring unit of claim 17, wherein the first set of coil springs and the second set of coil springs are compressively encased in a fabric pocket and arranged in strings.

19. The coil innerspring unit of claim 17, wherein each string consists of the coil springs from the first set or the second set.

20. The coil innerspring unit of claim 17, wherein each string comprises coil springs from the first set and the second set.

21. The coil innerspring unit of claim 17, wherein the coil springs in the first and second sets are subjected to different heat treatments.

22. The coil innerspring unit of claim 17, wherein the coil springs in the first set is heat treated and the coils springs in the second sets are not heat treated.
